(19) United States
(12) Patent Application Publication
(10) Pub. No.: US 2023/0331208 A1
(43) Pub. Date: Oct. 19, 2023

(54) BRAKE FLUID PRESSURE CONTROL APPARATUS

(71) Applicant: ADVICS CO., LTD., Kariya-shi (JP)

(72) Inventor: Shingo ONODA, Kariya-shi (JP)

(73) Assignee: ADVICS CO., LTD., Kariya-shi (JP)

(21) Appl. No.: 18/043,682

(22) PCT Filed: Sep. 29, 2021
(86) PCT No.: PCT/JP2021/035852

§ 371 Date: Mar. 1, 2023

(30) Foreign Application Priority Data
Sep. 29, 2020 (JP) 2020-164165

(51) Int. Cl. B60T 8/32; G01D 5/16; B60T 13/74; F15B 15/28

(52) U.S. Cl. CPC B60T 13/745; B60T 8/326; F15B 15/2815; G01D 5/16; B60T 2220/04

(57) ABSTRACT

In a brake fluid pressure control apparatus, a sensing device is integrally fixed to a master piston. The sensing device including the body to be sensed, which may include a magnet, and a sensing body, which may include a sensor. The sensing bodying sensing an axial position of the master piston without relative movement, that is, without providing play. This arrangement improves the sensing precision of the sensing device. Since it is not necessary to provide a member separate from the master piston in order to retain the body to be sensed, it is possible to achieve downsizing of the brake fluid pressure control apparatus.

### TECHNICAL FIELD

The present disclosure relates to a brake fluid pressure control apparatus.

### BACKGROUND ART

Conventionally, for example, a brake fluid pressure control apparatus disclosed in Patent Literature 1 is known. This conventional brake fluid pressure control apparatus includes a master piston protruding from a fluid pressure block and a rod arranged in parallel with the master piston. The rod is coupled to the master piston via a cap attached to the master piston and moves axially together with the master piston. In the conventional brake fluid pressure control apparatus, a permanent magnet is assembled to the rod, and a sensor connected to an electronic control unit is arranged so as to face the permanent magnet. Due to this, the sensor senses the stroke amount of the rod, that is, the coupled master piston on the basis of the change in the magnetic field direction due to the movement of the permanent magnet together with the rod.

### CITATIONS LIST

### Patent Literature

Patent Literature 1: U.S. Patent No. 10507811

### BRIEF SUMMARY

### Technical Problems

In the conventional brake fluid pressure control apparatus, the rod to which the permanent magnet sensed by the sensor is assembled moves axially together with the master piston coupled via the cap. In this case, since the rod and the master piston are inserted into and supported by different bores in the fluid pressure block, a relative position between the rod and the piston can fluctuate during movement due to dimensional tolerance of the rod and the piston or each bore. Therefore, in order to allow this relative movement fluctuation, it is necessary to provide play between the cap and the rod or between the cap and the piston. For this reason, the master piston and the rod do not move axially in an exactly matched manner by the amount of the provided play, and as a result, even if the sensor accurately detects a change in the magnetic field direction of the permanent magnet assembled to the rod, the sensing precision of the stroke amount of the master piston to be sensed may decrease.

In the conventional brake fluid pressure control apparatus, it is necessary to arrange the master piston and the rod in parallel. For this reason, for example, a fluid path formed in a hydraulic block, a control valve to be assembled, and the like cannot be formed or arranged in the moving direction of the rod. As a result, an increase in the size of the fluid pressure block and an increase in the size of the brake fluid pressure control apparatus may be caused.

The present disclosure has been made to solve the above problems, and an object thereof is to provide a brake fluid pressure control apparatus that achieves both improvement in sensing precision and compactness.

### Solutions to Problems

A brake fluid pressure control apparatus according to the present disclosure integrally includes, in a body, a master cylinder that has a master piston and generates a fluid pressure, a sensing device that electrically senses an axial position of the master piston, and a fluid pressure control device that controls a brake fluid pressure supplied to a wheel cylinder on a basis of a sensing signal indicating the axial position sensed by the sensing device, in which one of a sensing body and a body to be sensed constituting the sensing device is integrally fixed to the master piston.

### Advantageous Effects

According to this, one of the sensing body and the body to be sensed constituting the sensing device can be integrally fixed to the master piston. This allows the master piston and one of the sensing body and the body to be sensed to move axially together with the master piston without relative movement, that is, without providing play. Therefore, the sensing body can extremely accurately sense the movement of the body to be sensed, that is, the axial position of the master piston, and the sensing precision of the sensing device can be improved.

It is not necessary to provide a member separate from the master piston in order to retain one of the sensing body and the body to be sensed. This eliminates the need to secure a space for arranging a separate member and a space for operating the separate member, and as a result, it is possible to achieve downsizing of the brake fluid pressure control apparatus.

### BRIEF DESCRIPTION OF DRAWINGS

FIG. 1 is a view illustrating a configuration of a brake system including a brake fluid pressure control apparatus according to an embodiment of the present disclosure.

FIG. 2 is a view of the brake fluid pressure control apparatus as viewed from a side where an electric motor and an electric cylinder apparatus are assembled.

FIG. 3 is a view of the brake fluid pressure control apparatus as viewed from an attachment portion side.

FIG. 4 is a cross-sectional view for explaining a configuration of a sensing device.

FIG. 5 is a view for explaining sensing of an axial position (stroke amount) by the sensing device when the master piston is displaced.

FIG. 6 is a view for explaining sensing of an axial position (stroke amount) by the sensing device when the master piston is further displaced from the state illustrated in FIG. 5.

FIG. 7 is a view of a brake fluid pressure control apparatus according to a second embodiment as viewed from a side where an electric motor and an electric cylinder apparatus are assembled.

FIG. 8 is a view of the brake fluid pressure control apparatus according to the second embodiment as viewed from the attachment portion side.

### DESCRIPTION OF EMBODIMENTS

Hereinafter, embodiments of the present disclosure will be described with reference to the drawings. In the following embodiments, the same or equivalent parts are denoted by the same reference numerals in the drawings. Each drawing used for the description is a conceptual diagram, and the shape of each part is not necessarily strict in some cases.

### (1. Outline of Brake Fluid Pressure Control Apparatus 10)

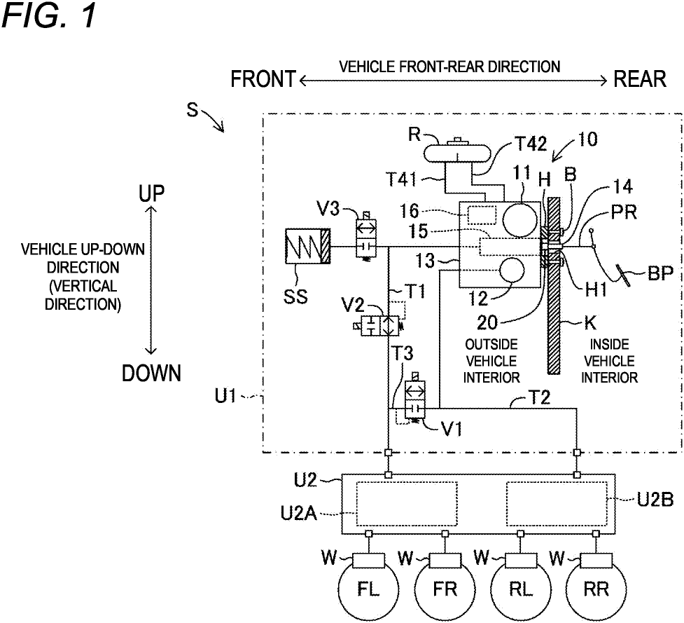

As illustrated in FIG. 1, a brake fluid pressure control apparatus 10 is assembled outside a vehicle interior with respect to a partition wall K (also called a dashboard, a dash panel, or a dash cowl) that partitions an inside of the vehicle interior from an outside of the vehicle interior on a front side in a vehicle front-rear direction. For example, an internal combustion engine, a driving motor, an inverter, a fuel cell stack, and the like are arranged or a luggage room is arranged outside the vehicle interior on the front side in the vehicle front-rear direction.

The brake fluid pressure control apparatus 10 of the present embodiment generates a brake fluid pressure in accordance with the operation amount of a brake operation member such as a brake pedal BP by the driver arranged in the vehicle interior, and supplies the brake fluid pressure to four wheel cylinders W arranged on the front, rear, left, and right of the vehicle. Therefore, the brake fluid pressure control apparatus 10 mainly includes an electric motor 11 constituting a fluid pressure control device, an electric cylinder apparatus 12 driven by the electric motor 11 to generate a brake fluid pressure, and a body 13 in which a fluid path connected to the electric cylinder apparatus 12 is formed and various control valves and the like are accommodated. Furthermore, the brake fluid pressure control apparatus 10 includes a master cylinder 15 that is accommodated in the body 13, has a master piston 14, and generates a brake fluid pressure.

In the master cylinder 15 of the present embodiment, the master piston 14 and the brake pedal BP are coupled via a push rod PR. In the brake fluid pressure control apparatus 10, as the operation amount on the brake pedal BP by the driver, on the basis of the stroke amount from the original position as the axial position of the master piston 14, a control apparatus 16 controls the operation of the electric motor 11, whereby the electric cylinder apparatus 12 generates the brake fluid pressure.

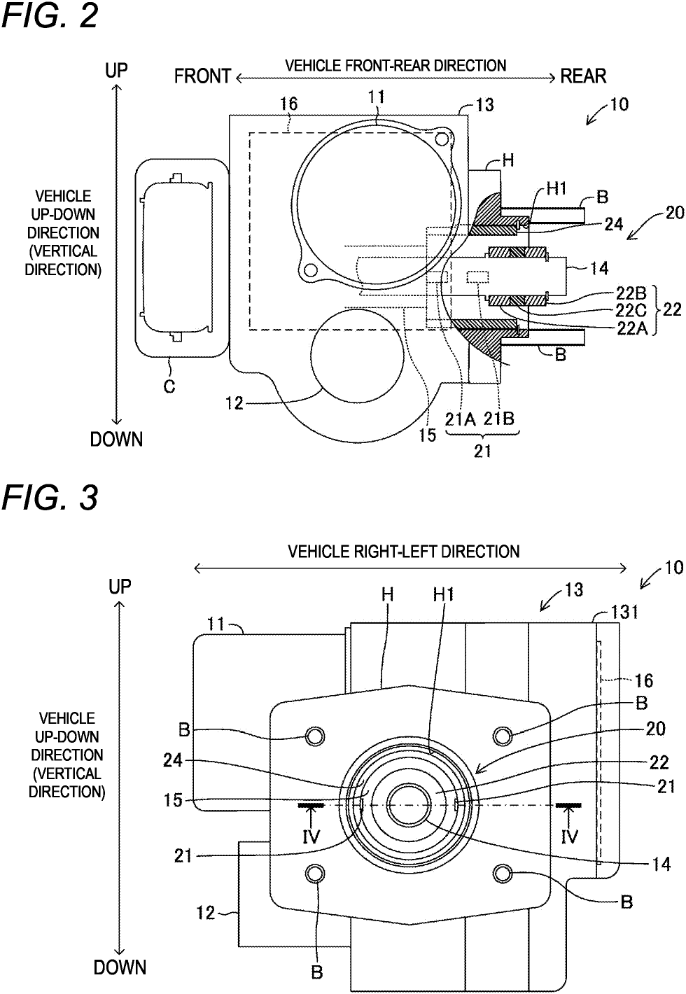

Therefore, the brake fluid pressure control apparatus 10 of the present embodiment includes a sensing device 20 that senses the axial position of the master piston 14. In the sensing device 20 of the present embodiment, a body 22 to be sensed is integrally fixed to the master piston 14 as one of a sensing body 21 and the body 22 to be sensed (see FIG. 2 and the like). Then, the sensing device 20 senses a physical quantity that changes with the movement of the body 22 to be sensed in which the sensing body 21 attached to the body 13 side is integrally fixed to the master piston 14, and outputs, to the control apparatus 16, a sensing signal corresponding to the change in the physical quantity having been sensed. Here, examples of the physical quantity sensed by the sensing body 21 include a change in a magnetic field direction, a change in impedance, and the like that change as the master piston 14, that is, the body 22 to be sensed moves. Due to this, the control apparatus 16 grasps the stroke amount, which is the axial position of the master piston 14, and controls the operation of the electric motor 11 in accordance with the stroke amount. Details of the configuration of the sensing device 20 will be described below.

Here, the brake fluid pressure control apparatus 10 of the present embodiment constitutes a brake system S of a vehicle as illustrated in FIG. 1. The brake system S includes an upstream unit U1 including the brake fluid pressure control apparatus 10 and a downstream unit U2 connected to each wheel cylinder W. The downstream unit U2 is, for example, an ESC actuator capable of pressurizing and depressurizing the wheel cylinder W.

The upstream unit U1 includes the brake fluid pressure control apparatus 10, and includes a fluid path T1, a fluid path T2, a communication path T3, brake fluid supply paths T41 and T42, a communication control valve V1, and a master cut valve V2.

The master cylinder 15 provided in the body 13 of the brake fluid pressure control apparatus 10 is connected to a reservoir R, and is configured to be able to mechanically supply the brake fluid pressure to the downstream unit U2 in accordance with the operation amount on the brake pedal BP. A stroke simulator SS and a simulator cut valve V3 are connected to the master cylinder 15. The stroke simulator SS generates a reaction force (load) with respect to the operation on the brake pedal BP. The simulator cut valve V3 is a normally closed type electromagnetic valve. The operation of the simulator cut valve V3 is controlled by a brake operation control apparatus not illustrated.

The fluid path T1 connects the master cylinder 15 and a first system U2A of the downstream unit U2. The fluid path T2 connects the brake fluid pressure control apparatus 10 and a second system U2B of the downstream unit U2. Here, the first system U2A controls pressurization and depressurization of the two wheel cylinders W (for example, the wheel cylinder W of a front left wheel FL and the wheel cylinder W of a front right wheel FR). The second system U2B controls pressurization and depressurization of the two wheel cylinders W (for example, the wheel cylinder W of a rear right wheel RR and the wheel cylinder W of a rear left wheel RL). The communication path T3 connects the fluid path T1 and the fluid path T2. The brake fluid supply path T41 connects the reservoir R and the electric cylinder apparatus 12 of the brake fluid pressure control apparatus 10. The brake fluid supply path T42 connects the reservoir R and the master cylinder 15. The electric cylinder apparatus 12 communicates with the reservoir R when the piston of the electric cylinder apparatus 12 is in the initial position, and is blocked from the reservoir R when the piston advances by a predetermined amount from the initial position. The master cylinder 15 communicates with the reservoir R when the master piston 14 is in the initial position, and communication with the reservoir R is blocked when the master piston 14 advances by a predetermined amount from the initial position. The reservoir R stores the brake fluid, and the internal pressure is maintained at atmospheric pressure.

The communication control valve V1 is a normally closed electromagnetic valve provided in the communication path T3. The communication control valve V1 switches the communication state and the block state of the communication path T3 in accordance with the energized state. The master cut valve V2 is a normally open type electromagnetic valve provided between a connection part between the fluid path T1 and the communication path T3 in the fluid path T1 and the master cylinder 15. The master cut valve V2 switches the communication state and the block state between the master cylinder 15 and the downstream unit U2 in accordance with the energized state.

Operation of the brake system S is controlled by the brake operation control apparatus (not illustrated). Specifically, when the ignition of the vehicle is turned on (at the time of starting the vehicle in the electric vehicle), the brake operation control apparatus switches the upstream unit U1 to a by-wire mode. In the by-wire mode, the communication control valve V1 is opened, the master cut valve V2 is closed, and the simulator cut valve V3 is opened.

That is, in the by-wire mode, the brake fluid pressure adjusted from the brake fluid pressure control apparatus 10 is supplied to each wheel cylinder W via the first system U2A and the second system U2B of the downstream unit U2. Therefore, in the by-wire mode, the brake fluid pressure control apparatus 10 supplies the brake fluid pressure in accordance with a target braking force determined on the basis of the operation amount on the brake pedal BP by the driver, that is, the sensing signal of the sensing device 20 that senses the stroke amount as the axial position of the master piston 14.

On the other hand, the brake operation control apparatus cancels the by-wire mode in an emergency or the like. That is, in an emergency or the like, the brake operation control apparatus closes the communication control valve V1, opens the master cut valve V2, and closes the simulator cut valve V3. Due to this, the brake fluid pressure is supplied from the master cylinder 15 to the first system U2A of the downstream unit U2.

### (2. Details of Configuration of Brake Fluid Pressure Control Apparatus 10)

Next, the configuration of the brake fluid pressure control apparatus 10 of the present embodiment will be described in detail. As illustrated in FIGS. 2 and 3, the brake fluid pressure control apparatus 10 includes the electric motor 11 and the electric cylinder apparatus 12 constituting the fluid pressure control device, and the body 13 integrally including the electric motor 11 and the electric cylinder apparatus 12 and constituting a part of the fluid pressure control device. The brake fluid pressure control apparatus 10 includes the master cylinder 15 having the master piston 14 and accommodated in the body 13. Furthermore, the brake fluid pressure control apparatus 10 includes the control apparatus 16 that controls the operation of the electric motor 11.

The brake fluid pressure control apparatus 10 includes the sensing device 20 that detects a displacement amount in the axial direction of the master piston 14, that is, a stroke amount from the original position representing the axial position. Here, in the present embodiment, as illustrated in FIGS. 2 and 3, the sensing body 21 of the sensing device 20 is attached to the attachment portion H assembled to the outside of the body 13. The attachment portion H includes a plurality of (four in the present embodiment) stud bolts B for fixing the brake fluid pressure control apparatus 10 to the partition wall K, and an insertion part H1 through which the master piston 14 (alternatively, the push rod PR) is inserted.

The sensing body 21 of the present embodiment is arranged outside the body 13 by being attached to the attachment portion H. Then, the body 22 to be sensed of the present embodiment is integrally fixed to the master piston 14. Due to this, the sensing body 21 of the present embodiment is attached so as to oppose the body 22 to be sensed integrally fixed to the outer periphery of the master piston 14 on the inner periphery of the tubular (cylindrical) insertion part H1 provided in the attachment portion H.

The electric motor 11 generates a rotational driving force and supplies the generated rotational driving force to the electric cylinder apparatus 12. The electric cylinder apparatus 12 mainly includes a cylinder, a piston, a linear motion conversion mechanism, and the like that are not illustrated. In the electric cylinder apparatus 12, the linear motion conversion mechanism converts the rotational motion of the rotation shaft of the electric motor 11 into the linear motion of the linear motion portion, thereby sliding the piston in the cylinder. The linear motion conversion mechanism includes main components such as a ball screw, a ball screw nut, a roller screw, and a roller screw nut, and the ball screw and the roller screw linearly move as a linear motion portion. Then, in the electric cylinder apparatus 12, the piston compresses the brake fluid in the fluid pressure chamber formed in the cylinder with the movement of the linear motion portion, thereby generating the brake fluid pressure.

The body 13 has a fluid path not illustrated connected to the fluid pressure chamber of the electric cylinder apparatus 12, and includes various control valves arranged in the fluid path. The body 13 accommodates therein a power transmission mechanism that transmits the rotational motion of the electric motor 11 to the linear motion conversion mechanism of the electric cylinder apparatus 12. The power transmission mechanism includes a plurality of gears including a drive gear fixed to the rotation shaft of the electric motor 11, for example. Then, the body 13 adjusts the fluid pressure supplied from the electric cylinder apparatus 12 by the various control valves and the like, and supplies the adjusted fluid pressure, that is, the brake fluid pressure to each wheel cylinder W of the vehicle. The body 13 is assembled with a connector C for electrically connecting the brake fluid pressure control apparatus 10 and the outside.

The master piston 14 is coupled to the brake pedal BP via the push rod PR (see FIG. 1), and as illustrated in FIG. 2, is inserted through the insertion part H1 of the attachment portion H assembled to the outside of the body 13. The master cylinder 15 generates fluid pressure (master cylinder pressure) when the master piston 14 moves axially in response to the operation on the brake pedal BP. In the by-wire mode, the master cylinder 15 is connected to the stroke simulator SS (see FIG. 1). Due to this, the driver receives a reaction force with respect to the operation on the brake pedal BP.

The control apparatus 16 is an electronic substrate having a microcomputer as a main component. As illustrated in FIG. 3, the control apparatus 16 is arranged on a side opposite to the electric motor 11 and the electric cylinder apparatus 12 with respect to the body 13. The control apparatus 16 controls the rotational drive of the electric motor 11 in order to generate the brake fluid pressure corresponding to the stroke amount of the master piston 14 sensed by the sensing device 20. The control apparatus 16 may set the target value of the output pressure (brake fluid pressure) of the brake fluid pressure control apparatus 10 on the basis of the stroke amount and the master cylinder pressure (reaction force pressure). Here, the control apparatus 16 is sealed by a lid in a state of being accommodated in an accommodation part 131 formed in the body 13.

### (2-1. Detailed Configuration of Sensing Device 20)

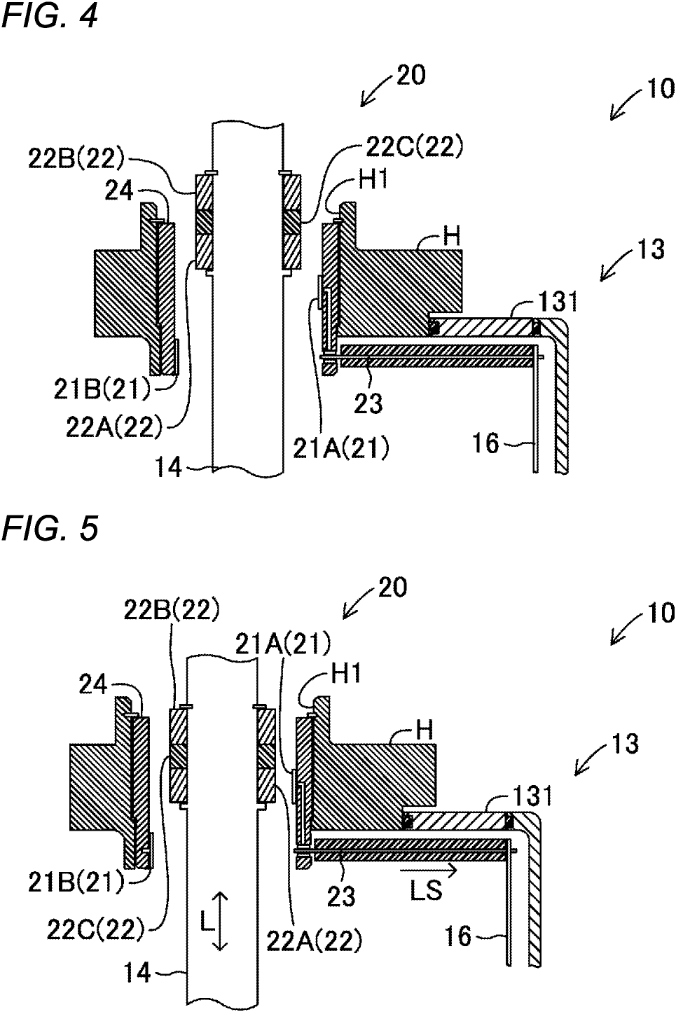

As illustrated in FIG. 4, the sensing device 20 of the present embodiment includes the sensing body 21 that senses (senses) a physical quantity that changes with the stroke amount (axial position) of the master piston 14, the body 22 to be sensed whose physical quantity is sensed by the sensing body 21, and a connection body 23 that electrically connects the sensing body 21 and the control apparatus 16 that controls the operation of the electric motor 11. The sensing body 21 and the body 22 to be sensed are arranged so as to oppose each other. In the present embodiment, the body 22 to be sensed is integrally fixed to the master piston 14 so as to be incapable of relative movement with respect to the master piston 14. In the present embodiment, the sensing body 21 is fixed to the attachment portion H (more specifically, the insertion part H1), which is the outside of the body 13.

Here, as the sensing body 21, for example, a sensor (for example, a sensor including a Hall element, an MR element, and a coil) adopting a Hall type/MR type or a coil type that detects a change in a magnetic field direction as a physical quantity can be exemplified. As the sensing body 21, for example, a sensor adopting an eddy current type that detects, as a stroke amount, a change in impedance caused by an eddy current generated in the metal body 22 to be sensed by a high-frequency magnetic field generated by the sensing body 21 itself as a physical quantity can also be exemplified. In the present embodiment described below, a case where the sensing body 21 is an MR sensor including an MR element and the body 22 to be sensed is a permanent magnet will be described as an example.

The connection body 23 electrically connects the sensing body 21 and the control apparatus 16. As the connection body 23, for example, a bus bar, a flexible wire, or the like can be used. In the present embodiment, a case of use of a bus bar as the connection body 23 will be exemplified. The connection body 23 may be electrically directly connected to the sensing body 21, or may be electrically connected to the sensing body 21 via a support member 24 that supports the sensing body 21.

Next, the sensing device 20 of the present embodiment will be specifically described. As illustrated in FIG. 4, the sensing body 21 of the sensing device 20 is attached to the inner periphery of the insertion part H1 of the attachment portion H. As an example, the sensing body 21 of the present embodiment is formed by a pair of MR sensors 21A and 21B. The MR sensors 21A and 21B (sensing body 21) are arranged apart from each other in the circumferential direction of the insertion part H1, for example, apart by 180 degrees in the circumferential direction. Furthermore, the MR sensors 21A and 21B (sensing body 21) are attached so as to be shifted from each other in the axial direction of the master piston 14.

The sensing body 21 is provided in the insertion part H1 via the cylindrical support member 24 made of a resin insulating member. As illustrated in FIG. 4, the support member 24 is formed to extend (protrude) from the insertion part H1 toward the inside of the body 13 relative to the insertion part H1 in the axial direction of the insertion part H1. Inside the support member 24, a wiring electrically connected to the sensing body 21 is provided so as to reach the above-described extension portion, and the sensing body 21 is electrically connected to the control apparatus 16 (electronic substrate) accommodated in the accommodation part 131 via the connection body 23 whose periphery is covered with a resin insulating member. The connection body 23 and the above-described insulating member covering the connection body 23 constitute a connection column provided between the above-described extension portion of the support member 24 and the electronic substrate (control apparatus 16) in a standing posture with respect to them.

Thus, in the present embodiment, since the bus bar is used as the connection body 23, the connection body 23 can be fixed to the electronic substrate (control apparatus 16) or the support member 24 in a standing posture in advance at a stage, for example, before the connection work between the electronic substrate (control apparatus 16) and the sensing body. Therefore, for example, when the electronic substrate (control apparatus 16) is assembled to the body 13, the electrical connection work between the electronic substrate (control apparatus 16) and the sensing body 21 is facilitated by the connection body 23 in the standing state. The insulating member covering the bus bar gives an insulating effect to the bus bar and contributes to further increasing the rigidity as the connection column. Even in a case where, for example, a flexible wire having rigidity smaller than that of the bus bar is used as the connection body 23 instead of the bus bar described above, the same effect as described above can be obtained by configuring a connection column having high rigidity by covering the periphery of the flexible wire with a resin insulating member or the like.

In the present embodiment, as illustrated in FIG. 4, the connection body 23 and the support member 24 are configured as separate bodies, and the support member 24 and the connection body 23 are electrically connected in a state where the support member 24 is electrically connected to and supported by the sensing body 21 (MR sensor). However, the connection body 23 and the support member 24 may be integrally configured.

As illustrated in FIG. 4, the body 22 to be sensed of the sensing device 20 is fixed so as to be incapable of relative movement (integral) with respect to the outer periphery of the master piston 14. The body 22 to be sensed of the present embodiment includes a pair of annular permanent magnets 22A and 22B, and an insulator 22C arranged between the permanent magnets 22A and 22B separated along the axial direction of the master piston 14. That is, in the body 22 to be sensed of the present embodiment, the two permanent magnets 22A and 22B are arranged side by side along the axial direction of the master piston 14 via the insulator 22C.

### (2-2. Detection of Stroke Amount by Sensing Device 20)

In the brake fluid pressure control apparatus 10, as described above, in order to supply the brake fluid pressure, the sensing device 20 accurately senses the axial position, that is, a stroke amount L of the master piston 14. In the present embodiment, the sensing body 21 is formed of the two MR sensors 21A and 21B, and the body 22 to be sensed is formed of the two permanent magnets 22A and 22B, so that the displacement direction to the axial direction of the master piston 14 can also be accurately sensed.

Specifically, assume that the state illustrated in FIG. 4 is a state in which the brake pedal BP is not operated by the driver and a state in which the master piston 14 is not advanced with respect to the master cylinder 15, that is, a state in which the master piston 14 is in the original position. Then, in the state of FIG. 5 in which the brake pedal BP is operated by the driver and the master piston 14 is pushed forward from the original position via the push rod PR, the MR sensor 21A of the sensing body 21 arranged at a position axially apart from the body 13 in the insertion part H1 senses the change in the magnetic field direction in the permanent magnet 22A of the body 22 to be sensed arranged at a position axially close to the body 13 in the master piston 14.

A sensing signal LS indicating the change in the magnetic field direction sensed by the MR sensor 21A is output to the control apparatus 16 via the support member 24 and the connection body 23. In the state of FIG. 5, the MR sensor 21B of the sensing body 21 arranged at a position axially close to the body 13 in the insertion part H1 has not yet output the sensing signal LS indicating the change in the magnetic field direction. The control apparatus 16 determines the stroke amount L of the master piston 14 according to the sensing signal LS acquired from the MR sensor 21A. In this case, the control apparatus 16 grasps that the master piston 14 has advanced from the original position on the basis of the fact that the sensing signal LS has not been acquired from the MR sensor 21B.

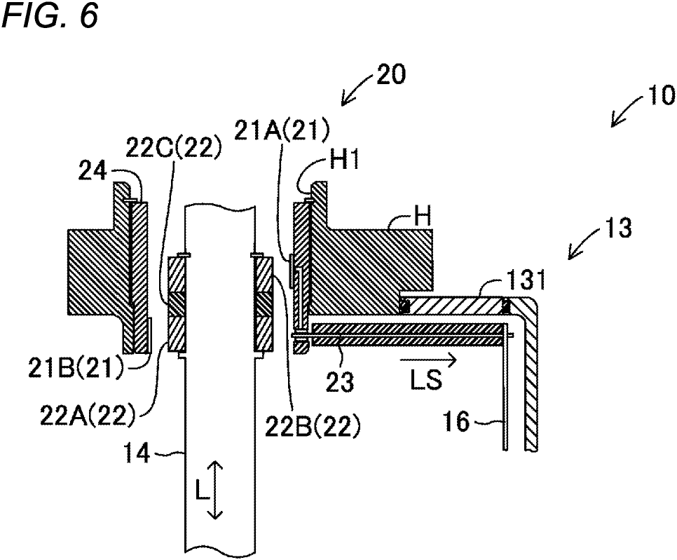

Furthermore, when the master piston 14 is pushed forward via the push rod PR, the state illustrated in FIG. 5 is changed to the state illustrated in FIG. 6. In the state illustrated in FIG. 6, the MR sensor 21B of the sensing body 21 senses a change in the magnetic field direction in the permanent magnet 22A of the body 22 to be sensed. In the state illustrated in FIG. 6, the MR sensor 21A of the sensing body 21 senses a change in the magnetic field direction in the permanent magnet 22B of the body 22 to be sensed arranged at a position axially separated from the body 13 in the master piston 14.

Each sensing signal LS indicating the change in the magnetic field direction sensed by the MR sensor 21A and the MR sensor 21B is output to the control apparatus 16 via the connection body 23. The control apparatus 16 determines the stroke amount L of the master piston 14 according to the sensing signal LS acquired from each of the MR sensor 21A and the MR sensor 21B. In this case, the control apparatus 16 accurately grasps that the master piston 14 has further advanced from the original position on the basis of the fact that the sensing signal LS has been acquired from each of the MR sensor 21A and the MR sensor 21B.

Then, in a situation where the operation on the brake pedal BP by the driver is released, the master piston 14 is positioned in the original position as illustrated in FIG. 4 through the state illustrated in FIG. 5 from the state illustrated in FIG. 6. In a situation where the operation on the brake pedal BP is slightly returned by the driver in order to adjust the braking force in the wheel cylinder W, for example, the state illustrated in FIG. 6 is changed to the state illustrated in FIG. 5.

In such a situation, the MR sensor 21B of the sensing body 21 changes from a state of sensing a change in the magnetic field direction of the permanent magnet 22A of the body 22 to be sensed to a state of not sensing a change in the magnetic field direction. That is, the control apparatus 16 changes from a state in which the sensing signal LS has been acquired from the MR sensor 21B to a state in which the sensing signal LS has not been acquired via the connection body 23. On the basis of this change in state, the control apparatus 16 can accurately grasp that the master piston 14 is displaced from the advanced position to the direction of the original position.

As can be understood from the above description, the brake fluid pressure control apparatus 10 integrally includes, in the body 13, the master cylinder 15 that has the master piston 14 and generates the brake fluid pressure, the sensing device 20 that electrically senses the stroke amount L, which is the axial position, of the master piston 14, and the electric motor 11 and the electric cylinder apparatus 12 constituting the fluid pressure control device that controls the brake fluid pressure supplied to the wheel cylinder W on the basis of the sensing signal LS indicating the stroke amount L sensed by the sensing device 20. In the brake fluid pressure control apparatus 10 of the present embodiment, the body 22 to be sensed (the permanent magnet 22A and the permanent magnet 22B), which is one of the sensing body 21 (the MR sensor 21A and the MR sensor 21B) and the body 22 to be sensed (the permanent magnet 22A and the permanent magnet 22B) constituting the sensing device 20, is integrally fixed to the master piston 14.

This makes it possible to integrally fix, to the master piston 14, the body 22 to be sensed (the permanent magnet 22A and the permanent magnet 22B), which is one of the sensing body 21 (the MR sensor 21A and the MR sensor 21B) and the body 22 to be sensed (the permanent magnet 22A and the permanent magnet 22B) constituting the sensing device 20. This allows the master piston 14 and the body 22 to be sensed (the permanent magnet 22A and the permanent magnet 22B) to move axially together with the master piston 14 without relative movement, that is, without providing play. Therefore, the sensing body 21 (the MR sensor 21A and the MR sensor 21B) can extremely accurately sense the axial position of the body 22 to be sensed (the permanent magnet 22A and the permanent magnet 22B), that is, the master piston 14, and can improve the sensing precision of the sensing device 20.

It is not necessary to provide a member separate from the master piston 14 in order to retain the body 22 to be sensed (the permanent magnet 22A and the permanent magnet 22B), which is one of the sensing body 21 (the MR sensor 21A and the MR sensor 21B) and the body 22 to be sensed (the permanent magnet 22A and the permanent magnet 22B). This eliminates the necessity of securing a space for arranging a separate member and a space for operating the separate member, and as a result, can achieve downsizing of the brake fluid pressure control apparatus 10.

In this case, the body 13 is integrally provided with the attachment portion H for fixing to the partition wall K that partitions the vehicle interior of the vehicle from the vehicle exterior. The attachment portion H extends in the axial direction along the outer peripheral surface of the master piston 14 and has the insertion part H1 through which the master piston 14 is inserted toward the inside of the body 13. The body 22 to be sensed (the permanent magnet 22A and the permanent magnet 22B), which is one of the sensing body 21 (the MR sensor 21A and the MR sensor 21B) and the body 22 to be sensed (the permanent magnet 22A and the permanent magnet 22B) constituting the sensing body 21 fixed to the master piston 14, is arranged in the axial region of the insertion part H1. In this case, in the present embodiment, the sensing body 21 (the MR sensor 21A and the MR sensor 21B), which is the other of the sensing body 21 (the MR sensor 21A and the MR sensor 21B) and the body 22 to be sensed (the permanent magnet 22A and the permanent magnet 22B), is provided on the body 13 side in the insertion part H1. In this case, the insertion part H1 is formed in a tubular shape protruding outward of the body 13, and a part of the insertion part H1 is formed to penetrate the partition wall K from the outside of the vehicle interior toward the inside of the vehicle interior.

According to these, the sensing body 21 (the MR sensor 21A and the MR sensor 21B) can be provided in the axial region of the tubular insertion part H1 not having a main function other than inserting the master piston 14 and the push rod PR through the partition wall K. This allows a dead space in the vehicle to be effectively used.

In this case, the brake fluid pressure control apparatus 10 includes the support member 24 electrically connected to the electronic substrate (the control apparatus 16) arranged in the body 13 apart from the insertion part H1 via the connection body 23 and extending toward the inside of the body 13 relative to the insertion part H1 in the axial direction of the insertion part H1, and the sensing body 21 (the MR sensor 21A and the MR sensor 21B) is electrically connected to the support member 24 and is provided in the insertion part H1 via the support member 24.

This can separate the sensing body 21 (the MR sensor 21A and the MR sensor 21B) and the control apparatus 16 (electronic substrate) from each other in the radial direction of the master piston 14 while satisfactorily guiding the wiring between the sensing body 21 and the control apparatus 16 by the connection body 23. This can improve the degree of freedom in designing the attachment portion H, for example, the attachment portion H (insertion part H1) can be formed to have a small diameter such that the attachment portion H, more specifically, the insertion part H1 is arranged close to the master piston 14. In the case of use of use of a bus bar as the connection body 23, it is not necessary to form a wiring guide part such as a through hole in the body 13 itself or to add a dedicated member for wiring guide. This can achieve downsizing of the body 13, and can reduce the manufacturing cost of the body 13.

The plurality of the sensing bodies 21 (the MR sensor 21A and the MR sensor 21B) are provided, and the plurality of sensing bodies 21 (the MR sensor 21A and the MR sensor 21B) can be arranged along the axial direction of the master piston 14. The plurality of the sensing bodies 21 (the MR sensor 21A and the MR sensor 21B) are provided, and the plurality of sensing bodies 21 (the MR sensor 21A and the MR sensor 21B) can be arranged along the circumferential direction of the master piston 14. Furthermore, the plurality of bodies 22 to be sensed (the permanent magnet 22A and the permanent magnet 22B) are provided, and the plurality of bodies 22 to be sensed (the permanent magnet 22A and the permanent magnet 22B) can be arranged side by side along the axial direction of the master piston 14.

In this manner, the plurality of sensing bodies 21 (the MR sensor 21A and the MR sensor 21B) and the plurality of bodies 22 to be sensed (the permanent magnet 22A and the permanent magnet 22B) can be arranged with respect to the master piston 14. This can improve the sensing precision of the sensing device 20, and can reduce the occupancy length in the axial direction.

### 3. Second Embodiment

In the first embodiment described above, the sensing body 21 of the sensing device 20 is provided in the attachment portion H assembled to the outside of the body 13, more specifically, in the insertion part H1 of the attachment portion H. That is, in the first embodiment described above, the sensing body 21 is provided outside the body 13, and senses the stroke amount from the axial position, that is, the original position of the master piston 14.

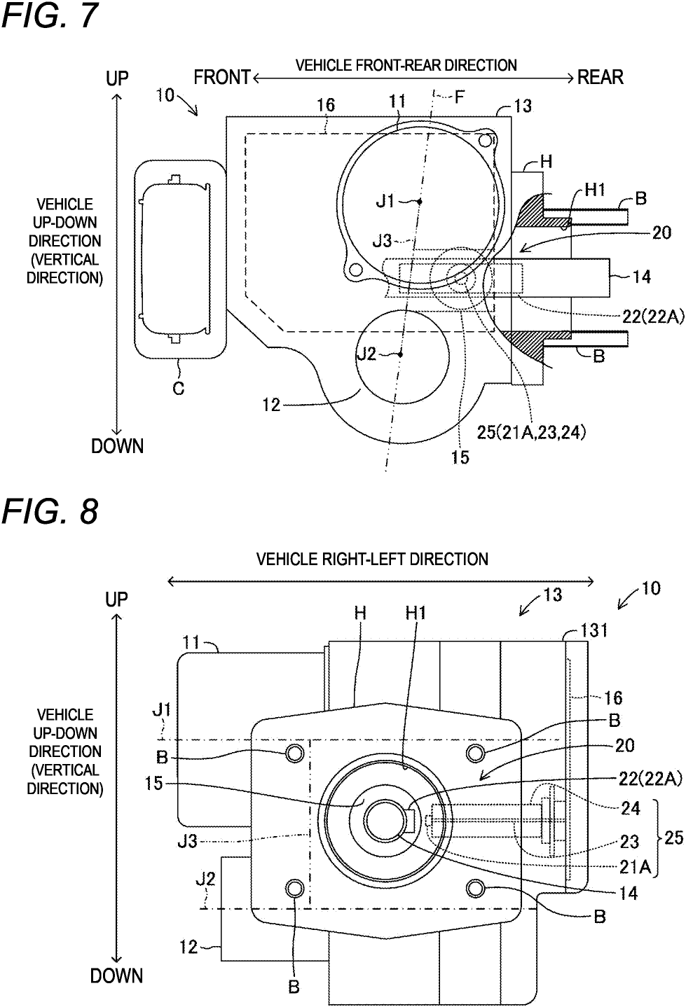

As illustrated in FIGS. 7 and 8, in particular, in a case where the electric motor 11 and the electric cylinder apparatus 12 are assembled to the body 13 so that the axis of the electric motor 11 and the axis of the electric cylinder apparatus 12 become juxtaposed (for example, juxtaposed and parallel), and the master cylinder 15 is accommodated in the body 13 so as to intersect an axis J1 and an axis J2 of the electric motor 11 and the electric cylinder apparatus 12, respectively, (in the present embodiment, so as to be orthogonal to the axes J1 and J2), a sensing body 25 of the sensing device 20 can be arranged inside the body 13. In this case, the sensing body 25 of the sensing device 20 is arranged so as to be between the electric motor 11 and the electric cylinder apparatus 12 in the arrangement direction (vertical direction in the present embodiment) of the electric motor 11 and the electric cylinder apparatus 12 inside the body 13.

More specifically, for example, in a state where the brake fluid pressure control apparatus 10 is mounted on the vehicle, on an assumption of a vertical projection plane (corresponding to the paper surface of FIGS. 7 and 8), in a case where the electric motor 11, the electric cylinder apparatus 12, the body 13, and the sensing body 25 are projected on the projection plane, the sensing body 25 is arranged between the electric motor 11 and the electric cylinder apparatus 12 in the arrangement direction of the electric motor 11 and the electric cylinder apparatus 12 on the projection plane. In the present embodiment, the sensing body 25 is arranged between an imaginary horizontal plane (a plane orthogonal to a straight line extending in the vertical direction) passing through an arbitrary point on the axis J1 of the electric motor 11 inside the body 13 and an imaginary horizontal plane passing through an arbitrary point on the axis J2 of the electric cylinder apparatus 12.

As illustrated in FIG. 7, in a case where an imaginary plane F is assumed, the sensing body 25 is arranged apart from the imaginary plane F in a normal direction of the imaginary plane F. Here, in a case of assuming an imaginary line J3 connecting the axes J1 and J2 (more specifically, an arbitrary point on the axis J1 in the body 13 and similarly an arbitrary point on the axis J2) of the electric motor 11 and the electric cylinder apparatus 12, respectively, as illustrated by the two-dot chain lines in FIGS. 7 and 8, the imaginary plane F is defined as a plane including at least one of the axis J1 and the axis J2 and the imaginary line J3 as illustrated in FIG. 7. In the second embodiment, since an example in which the axis J1 of the electric motor 11 and the axis J2 of the electric cylinder apparatus 12 are parallel to each other is presented, the imaginary plane F becomes a plane including the axis J1 of the electric motor 11, the axis J2 of the electric cylinder apparatus 12, and the imaginary line J3 as illustrated in FIG. 7. A plane parallel to the imaginary plane F and a plane orthogonal to the imaginary plane F may be assumed as the projection plane described above.

In the second embodiment, as indicated by the broken lines in FIGS. 7 and 8, the sensing body 25 of the sensing device 20 is formed in, for example, a substantially cylindrical shape. The sensing body 25 of the second embodiment includes the sensing body 21 (the MR sensor 21A) arranged on a tip end side of the support member 24 formed in a cylindrical shape so as to oppose the body 22 to be sensed (for example, the permanent magnet 22A) integrally fixed to the master piston 14, and the connection body 23 extending inside the support member 24 and electrically connected to the electronic substrate of the control apparatus 16 on a rear end side. The sensing body 25 of the second embodiment is accommodated in an accommodation hole formed in the body 13 made of aluminum, for example, and is assembled inside the body 13.

As described above, in the brake fluid pressure control apparatus 10 of the second embodiment, the electric motor 11 and the electric cylinder apparatus 12 are arranged in the body 13 such that the axes of them are juxtaposed to each other, the body 22 to be sensed, which is one of the sensing body 25 (the MR sensor 21A) and the body 22 to be sensed (the permanent magnet 22A), is integrally fixed to the master piston 14, and the sensing body 25, which is the other, is arranged in the body 13 so as to be between the electric motor 11 and the electric cylinder apparatus 12 in the arrangement direction in which the electric motor 11 and the electric cylinder apparatus 12 are arranged in the body 13. In this case, the sensing body 25, which is the other of the sensing body 25 and the body 22 to be sensed, is arranged apart in the normal direction of the imaginary plane F from the imaginary plane F including the imaginary line J3 connecting the axis J1 and the axis J2 of the electric motor 11 and the electric cylinder apparatus 12, respectively, and at least one of the axis J2 of the electric motor 11 and the axis J2 of the electric cylinder 12 (in the second embodiment, since the axis J1 and the axis J2 are parallel to each other, both the axis J1 and the axis J2).

Therefore, also in the brake fluid pressure control apparatus 10 of the second embodiment, similarly to the first embodiment described above, the sensing body 25 of the sensing device 20 can sense the stroke amount of the master piston 14 with high sensing precision. By arranging the sensing body 25 between the electric motor 11 and the electric cylinder apparatus 12 apart in the normal direction of the imaginary plane F from the imaginary plane F including the axes of the electric motor 11 and the electric cylinder apparatus 12, it is possible to effectively use the space while avoiding a region that tends to be relatively narrow overlapping the imaginary plane F in the dead space generated between the electric motor 11 and the electric cylinder apparatus 12 inside the body 13, and it is possible to achieve downsizing of the brake fluid pressure control apparatus 10.

### 4. Modifications

In the brake fluid pressure control apparatus 10 of each of the above-described embodiments, the body 22 to be sensed, that is, the permanent magnet 22A, the permanent magnet 22B, and the insulator 22C, are integrally fixed to the master piston 14. However, it is possible to integrally fix the sensing body 21, that is, the MR sensor 21A and the MR sensor 21B, to the master piston 14, and to provide the body 22 to be sensed, that is, the permanent magnet 22A, the permanent magnet 22B, and the insulator 22C, in the insertion part H1 of the attachment portion H. Also in this case, it is possible to improve the sensing precision, achieve downsizing of the brake fluid pressure control apparatus 10, and obtaining the same effects as those of each of the above-described embodiments. In this case, in consideration of movement of the master piston 14, for example, a flexible wire can be used as the connection body 23 electrically connecting the sensing body 21 and the control apparatus 16. This allows the sensing signal LS from the sensing body 21 to be output and transmitted to the control apparatus 16.

In the brake fluid pressure control apparatus 10 of each of the above-described embodiments, the electric motor 11 is arranged upper than the electric cylinder apparatus 12 in the vehicle up-down direction (vertical direction) in the body 13. Due to this, even if fluid (brake fluid) leaks from the electric cylinder apparatus 12, it is possible to prevent the leaked fluid from entering the inside of the electric motor 11. Therefore, it is possible to simplify or arrange a seal structure or the like for preventing entry of fluid into the electric motor 11.

However, when the electric motor 11 and the electric cylinder apparatus 12 are arranged in the body 13, the arrangement of the electric motor 11 and the electric cylinder apparatus 12 in the up-down direction of the vehicle is not limited. That is, in the body 13, the electric cylinder apparatus 12 can be arranged upper than the electric motor 11 in the vehicle up-down direction (vertical direction). Also in this case, the same effects as those of each of the above-described embodiments can be obtained.

In each of the above-described embodiments, the electric motor 11 and the electric cylinder apparatus 12 are arranged on the same side of the body 13. However, the arrangement of the electric motor 11 and the electric cylinder apparatus 12 with respect to the body 13 is not limited to the arrangement on the same side of the body 13. For example, the electric motor 11 and the electric cylinder apparatus 12 can be arranged across the body 13. Even in this case, for example, the brake fluid pressure control apparatus 10 can be downsized by arranging the electric motor 11 and the electric cylinder apparatus 12 so as to partially overlap each other in the body 13.

In the first embodiment described above, the sensing body 21 of the sensing device 20 includes the two MR sensors 21A and 21B, and the body 22 to be sensed of the sensing device 20 includes the two permanent magnets 22A and 22B. In the second embodiment described above, the sensing body 25 of the sensing device 20 includes the one MR sensor 21A, and the body 22 to be sensed of the sensing device 20 includes the one permanent magnet 22A.

However, the numbers of the sensing body 21, the sensing body 25, and the body 22 to be sensed of the sensing device 20 are not limited. For example, the sensing body 21 of the sensing device 20 can include the one MR sensor 21A, the body 22 to be sensed of the sensing device 20 can include the two permanent magnets 22A and 22B, the sensing body 21 can include the two MR sensors 21A and 21B, and the body 22 to be sensed can include the one permanent magnet 22A. Even in these cases, the axial position of the master piston 14, that is, the stroke amount can be accurately sensed without providing play.

Furthermore, in each of the above-described embodiments, the insertion part H1 of the attachment portion H is formed to have a tubular shape and protrude so as to be inserted through the partition wall K. However, the shape of the insertion part H1 does not need to be tubular and protrude so as to be inserted through the partition wall K, and may be a through hole provided in the attachment portion H as long as the master piston 14 (or the push rod PR) can be inserted. Also in this case, one of the sensing body 21 and the body 22 to be sensed can be provided in the insertion part H1, which is a through hole, and the same effects as those of the above-described embodiments can be obtained.

1. A brake fluid pressure control apparatus integrally including, in a body, a master cylinder that has a master piston and generates a brake fluid pressure, a sensing device that electrically senses an axial position of the master piston, and a fluid pressure control device that controls a brake fluid pressure supplied to a wheel cylinder on a basis of a sensing signal indicating the axial position sensed by the sensing device,
wherein one of a sensing body and a body to be sensed constituting the sensing device is integrally fixed to the master piston.

2. The brake fluid pressure control apparatus according to claim 1, wherein
the body is integrally provided with an attachment portion for fixing to a partition wall separating an inside of a vehicle interior and an outside of the vehicle interior of a vehicle,
the attachment portion includes
an insertion part that extends in an axial direction along an outer peripheral surface of the master piston and through which the master piston is inserted toward an inside of the body, and
one of the sensing body and the body to be sensed fixed to the master piston
is arranged in an axial region of the insertion part.

3. The brake fluid pressure control apparatus according to claim 2, wherein another of the sensing body and the body to be sensed is provided on the body side in the insertion part.

4. The brake fluid pressure control apparatus according to claim 3 comprising:
a support member electrically connected to an electronic substrate arranged in the body apart from the insertion part and extending toward an inside of the body relative to the insertion part in an axial direction of the insertion part,
wherein the sensing body is electrically connected to the support member and is provided in the insertion part via the support member.

5. The brake fluid pressure control apparatus according to claim 2, wherein the insertion part is formed in a tubular shape protruding outward of the body, and a part of the insertion part penetrates the partition wall from the outside of the vehicle interior to the inside of the vehicle interior.

6. The brake fluid pressure control apparatus according to claim 1, wherein
the fluid pressure control device includes an electric motor and an electric cylinder apparatus in which a piston sliding in a cylinder is driven by the electric motor to generate a fluid pressure in a fluid pressure chamber formed in the cylinder,
the electric motor and the electric cylinder apparatus are arranged in the body in such a manner that axes of the electric motor and the electric cylinder apparatus are juxtaposed to each other, and
another of the sensing body and the body to be sensed is arranged inside the body to be between the electric motor and the electric cylinder apparatus in an arrangement direction in which the electric motor and the cylinder apparatus are arranged in the body.

7. The brake fluid pressure control apparatus according to claim 6, wherein the other of the sensing body and the body to be sensed is arranged apart in a normal direction of an imaginary plane from the imaginary plane including an imaginary line connecting the axes of the electric motor and the electric cylinder apparatus and at least one of an axis of the electric motor and an axis of the electric cylinder apparatus.

8. The brake fluid pressure control apparatus according to claim 1 comprising:
a plurality of the sensing bodies,
wherein the plurality of sensing bodies are arranged along an axial direction of the master piston.

9. The brake fluid pressure control apparatus according to claim 1 comprising:
a plurality of the sensing bodies,
wherein the plurality of sensing bodies are arranged along a circumferential direction of the master piston.

10. The brake fluid pressure control apparatus according to claim 1 comprising:
a plurality of the bodies to be sensed,
wherein the plurality of bodies to be sensed are arranged side by side along an axial direction of the master piston.

11. The brake fluid pressure control apparatus according to claim 3, wherein the insertion part is formed in a tubular shape protruding outward of the body, and a part of the insertion part penetrates the partition wall from the outside of the vehicle interior to the inside of the vehicle interior.

12. The brake fluid pressure control apparatus according to claim 4, wherein the insertion part is formed in a tubular shape protruding outward of the body, and a part of the insertion part penetrates the partition wall from the outside of the vehicle interior to the inside of the vehicle interior.

13. The brake fluid pressure control apparatus according to claim 2 comprising:
a plurality of the sensing bodies,
wherein the plurality of sensing bodies are arranged along an axial direction of the master piston.

14. The brake fluid pressure control apparatus according to claim 3 comprising:
a plurality of the sensing bodies,
wherein the plurality of sensing bodies are arranged along an axial direction of the master piston.

15. The brake fluid pressure control apparatus according to claim 4 comprising:
a plurality of the sensing bodies,
wherein the plurality of sensing bodies are arranged along an axial direction of the master piston.

16. The brake fluid pressure control apparatus according to claim 2 comprising:
a plurality of the sensing bodies,
wherein the plurality of sensing bodies are arranged along a circumferential direction of the master piston.

17. The brake fluid pressure control apparatus according to claim 3 comprising:
a plurality of the sensing bodies,
wherein the plurality of sensing bodies are arranged along a circumferential direction of the master piston.

18. The brake fluid pressure control apparatus according to claim 4 comprising:
a plurality of the sensing bodies,
wherein the plurality of sensing bodies are arranged along a circumferential direction of the master piston.

19. The brake fluid pressure control apparatus according to claim 2 comprising:
a plurality of the bodies to be sensed,
wherein the plurality of bodies to be sensed are arranged side by side along an axial direction of the master piston.

20. The brake fluid pressure control apparatus according to claim 3 comprising:
a plurality of the bodies to be sensed,
wherein the plurality of bodies to be sensed are arranged side by side along an axial direction of the master piston.
